(19) United States
(12) Patent Application Publication
(10) Pub. No.: US 2012/0261001 A1
(43) Pub. Date: Oct. 18, 2012

(54) AIR PRESSURE ADJUSTING APPARATUS

(75) Inventor: CHIA-SHIEN LIU, Tu-Cheng (TW)

(73) Assignee: HON HAI PRECISION INDUSTRY CO., LTD., Tu-Cheng (TW)

(21) Appl. No.: 13/217,261

(22) Filed: Aug. 25, 2011

(30) Foreign Application Priority Data
Apr. 14, 2011 (TW) 100113057

(51) Int. Cl. F16K 15/20

(52) U.S. Cl. 137/226

(57) ABSTRACT

An air pressure adjusting apparatus includes an inflator, an adjusting element, a pressure relief valve, an elastic element, and a pressing element. An adjusting hole, an inlet and an outlet are defined in the inflator. The adjusting hole, the inlet and the outlet communicate each other. The adjusting element is movable within the inflator. The pressure relief valve covers the adjusting hole to prevent airflow from escaping from the adjusting hole. The pressing element is secured to the adjusting element. The elastic element is located between the pressure relief valve and the pressing element. Wherein the pressing element is minutely adjustable in allowing the release of excess pressure through the valve.

### BACKGROUND

1. Technical Field

The disclosure generally relates to relief apparatuses, especially, to an air pressure adjusting apparatus of a printer.

2. Description of Related Art

An inkjet printer usually includes an ink box and an air pump. There is often an air adjusting apparatus connected between the ink box and the air pump to adjust the air pressure. The air adjusting apparatus includes a pressure relief valve. However, the air relief valve operates only at extreme levels and cannot allow slight or fine levels of air pressure adjustment, thus consistent and smooth delivery of ink is not always achieved.

Therefore, there is room for improvement within the art.

### BRIEF DESCRIPTION OF THE DRAWINGS

FIG. 1 is an exploded, isometric view of an exemplary embodiment of an air pressure adjusting apparatus.

FIG. 2 is a assembled view of the apparatus of FIG. 1.

FIG. 3 is a cross sectional view of FIG. 2, taken along lines III-III.

FIG. 4 is similar to FIG. 3, but showing a adjusting element being in motion.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

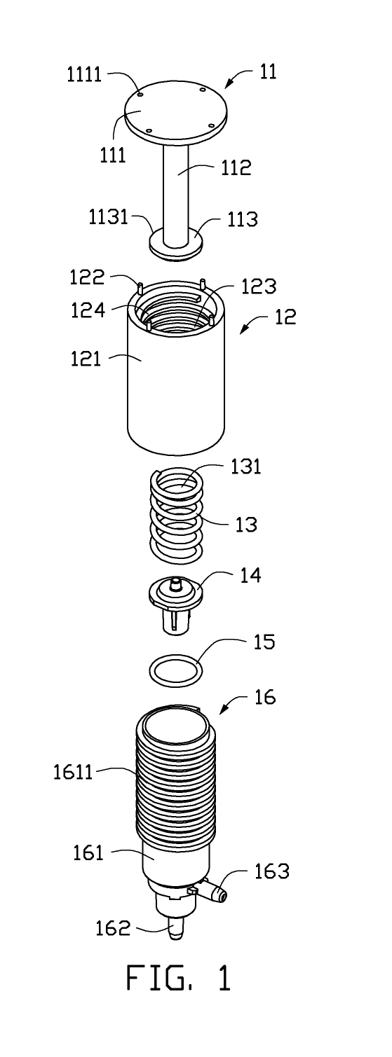

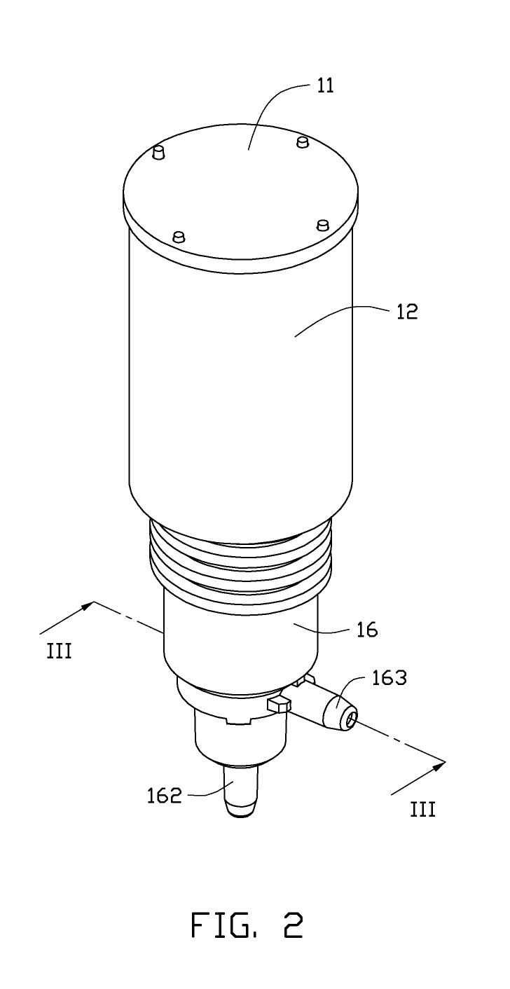

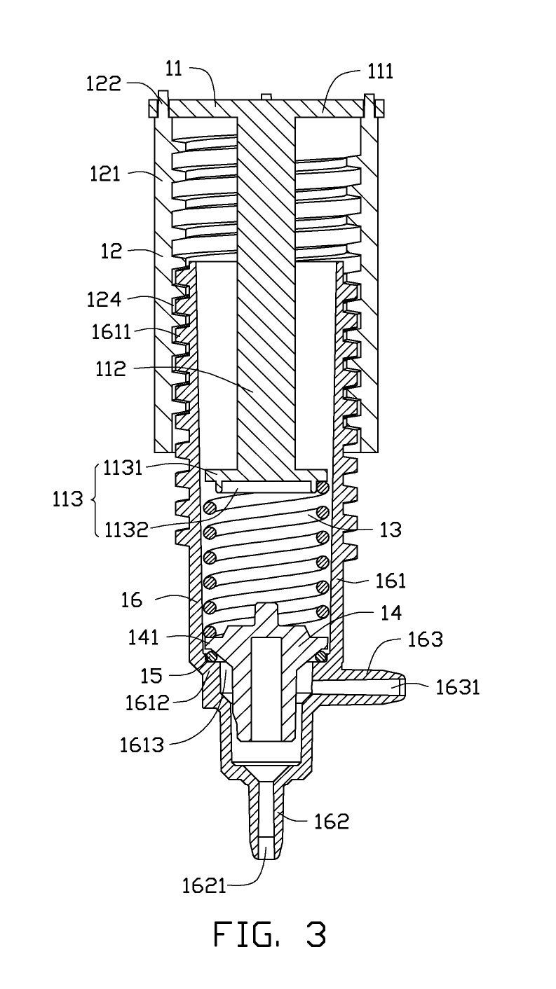

Referring to FIGS. 1, 2 and 3, an embodiment of an air pressure adjusting apparatus for a printer is shown. The air pressure adjusting apparatus includes a pressing element 11, an adjusting element 12 secured to the pressing element 11, an elastic element 13, a pressure relief valve 14, a gasket 15, and an inflator 16.

The pressing element 11 includes a mounting portion 111, a connecting shank 112 extending from the mounting portion 111, and pressing portion 113 extending from the connecting shank 112. Four mounting holes 1111 are defined in mounting portion 111. The mounting portion 111 is circular. The pressing portion 113 includes a pressing body 1131 and a locating protrusion 1132 extending from the pressing body 1131.

The adjusting element 12 includes an adjusting body 121 and four bosses or studs (securing portions 122) extending from the adjusting body 121 corresponding to the four mounting holes 1111. The adjusting body 121 is cylindrical and hollow (an inner hole 123 is defined in the adjusting body 121) and internally threaded (inner threads 124).

In one embodiment, the elastic element 13 is a commonplace coil spring with an internal void (opening 131).

The pressure relief valve 14 includes a loading portion 141. The cross sectional area of the loading portion 141 is slightly less than that of the inner hole 123. The gasket 15 is a seal made of an elastic material.

The inflator 16 includes a cave 161, an airflow input portion 162 extending from the cave 161, and an airflow output portion 163. The inflator 16 is threaded (outer threads 1611) and extends from an outer surface of the cave 161. The inflator 16 includes a support portion 1612 extending from an inner surface of the cave 161. The support portion 1612 is stepped in at least two stages. An adjusting hole 1613 is defined in the support portion 1612. An inlet 1621 is defined in the airflow input portion 162. An outlet 1631 is defined in the airflow output portion 163. The inlet 1621 is connected to the outlet 1631.

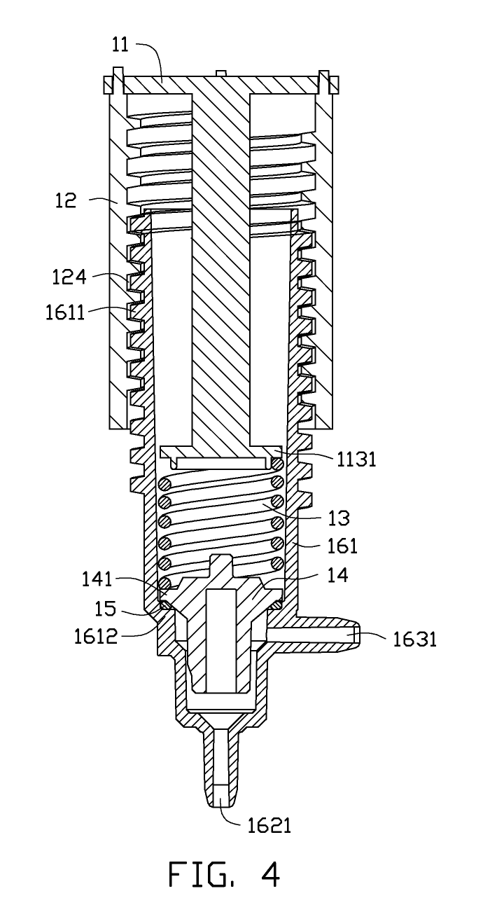

Referring to FIGS. 1 to 4, in assembly, the gasket 15 is placed on the support portion 1612 and the pressure relief valve 14 is placed on the gasket 15. The elastic element 13 is placed on the loading portion 141 of the pressure relief valve 14. The securing portions 122 of the adjusting element 12 are fitted into the mounting holes 1111 of the pressing element 11, thereby locating the pressing element 11 on the adjusting element 12. The adjusting element 12 is screwed down onto the inflator 16. At this time, the pressing body 1131 of the pressing portion 113 of the pressing element 11 is compressing the elastic element 13. The locating protrusion 1132 of the pressing portion 113 is disposed in the opening 131 of the elastic element 13, and the elastic element 13 pushes the loading portion 141 onto the gasket 15. The adjusting element 12 may be rotated up or down to adjust the force of the pressure relief valve 14 against the support portion 1612, thereby allowing very small differences in air pressure to cause an adjustment of the air pressure in the ink tanks. For example, when the adjusting element 12 is screwed down, the elastic element 13 presses the gasket 15 more strongly, thereby preventing air from escaping from the adjusting hole 1613 to relieve the air pressure. This feature substantially increases the sensitivity of the valve, to permit very fine adjustments to be made to the pressure yield point of the valve, and enhances the smoothness and delivery of the printing ink.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An air pressure adjusting apparatus, comprising:
an inflator defining an adjusting hole, an inlet and an outlet defined therein, the adjusting hole, the inlet and the outlet communicating each other;
an adjusting element, movable within the inflator;
a pressure relief valve covering the adjusting hole to prevent air from escaping from the adjusting hole;
a pressing element secured to the adjusting element; and
an elastic element located between the pressure relief valve and the pressing element;
wherein the pressing element is operable to press the elastic element to urge the pressure relief valve to contact the inflator when the adjusting element moves along a first direction relative to the inflator.

2. The air pressure adjusting apparatus of claim 1, wherein the adjusting element is screwed to the inflator, and is operable to be rotated to move in the first direction.

3. The air pressure adjusting apparatus of claim 2, wherein the adjusting element is cylindrical and hollow, and defines an inner thread, and the inflator defines an outer thread to engage with the inner thread.

4. The air pressure adjusting apparatus of claim 1, wherein the elastic element is adapted to be released when the adjusting element moves along a second direction opposite to the first direction.

5. The air pressure adjusting apparatus of claim 1, wherein the pressing element comprises a mounting portion, a connecting shank extending from the mounting portion, and a pressing portion extending from the connecting portion; the mounting portion is secured to the adjusting element; and the pressing portion presses the elastic element.

6. The air pressure adjusting apparatus of claim 5, wherein a mounting hole is defined in the mounting portion, and the adjusting element comprises a securing portion secured to the mounting hole.

7. The air pressure adjusting apparatus of claim 5, wherein an opening is defined in the elastic element; the pressing portion comprises a pressing body abutting the elastic element and a locating protrusion extending from the pressing body; and the locating protrusion is located in the opening.

8. The air pressure adjusting apparatus of claim 1, further comprising a gasket, wherein the inflator comprises a support portion surrounding the adjusting hole; the gasket is sandwiched between the pressure relief valve and the support portion.

9. The air pressure adjusting apparatus of claim 8, wherein the inflator comprises a cave; the support portion extends from an inner surface of the cave; and the support portion is circled.

10. An air pressure adjusting apparatus, comprising:
an inflator defining an airflow path therein, an adjusting hole defined in the airflow path;
an adjusting element movable within the inflator;
a pressure relief valve covering the adjusting hole to prevent air from escaping from the adjusting hole; and
a pressing element secured to the adjusting element, the pressing element operable to press the pressure relief valve in a first direction to enable the pressure relief valve to contact the inflator tightly when the adjusting element moves relative to the inflator in the first direction.

11. The air pressure adjusting apparatus of claim 10, wherein the adjusting element is screwed to the inflator, the adjusting element is adapted to be rotated to move in the first direction.

12. The air pressure adjusting apparatus of claim 11, wherein the adjusting element is cylindrical and hollow, the adjusting element defines a plurality of inner threads, and the inflator defines a plurality of outer threads to engage with the plurality of inner threads.

13. The air pressure adjusting apparatus of claim 10, wherein the pressing element comprises a mounting portion, a connecting shank extending from the mounting portion, and a pressing portion extending from the connecting portion; the mounting portion is secured to the adjusting element; and the pressing portion presses the pressure relief valve.

14. The air pressure adjusting apparatus of claim 13, wherein a mounting hole is defined in the mounting portion, and the adjusting element comprises a securing portion secured with the mounting hole.

15. The air pressure adjusting apparatus of claim 10, further comprises an elastic element placed between the pressing element and the pressure relief valve, the pressing element presses the elastic element to abut resiliently the pressure relief valve.

16. The air pressure adjusting apparatus of claim 15, wherein an opening is defined in the elastic element; the pressing element comprises a pressing portion; the pressing portion comprises a pressing body abut the elastic element and a locating protrusion extending from the pressing body; and the locating protrusion is disposed in the opening.

17. The air pressure adjusting apparatus of claim 15, further comprising a gasket, wherein the inflator comprises a support portion surrounding the adjusting hole; the gasket is sandwiched between the pressure relief valve and the support portion.

18. The air pressure adjusting apparatus of claim 17, wherein the inflator comprises a cave; the support portion extends from an inner surface of the cave; and the support portion is circled.

19. The air pressure adjusting apparatus of claim 15, wherein the elastic element is released when the adjusting element moves along a second direction opposite to the first direction.
